(19) United States
(12) Patent Application Publication
(10) Pub. No.: US 2015/0343567 A1
(43) Pub. Date: Dec. 3, 2015

(54) METHOD AND SYSTEM FOR FORMATION OF VERTICAL MICROVIAS IN OPAQUE CERAMIC THIN-PLATE BY FEMTOSECOND LASER PULSE

(71) Applicant: NATIONAL CHUNG SHAN INSTITUTE OF SCIENCE AND TECHNOLOGY, Longtan Township (TW)

(72) Inventors: Chih WANG, Longtan (TW); Chi-Haw CHIANG, Longtan (TW); Chih-Wei LUO, Hsinchu City (TW); Sheng-Yang TSENG, Hsinchu City (TW); Ya-Hsin TSENG, Hsinchu City (TW); Hui-Hsin CHU, Hsinchu City (TW)

(73) Assignee: NATIONAL CHUNG SHAN INSTITUTE OF SCIENCE AND TECHNOLOGY, Longtan Township (TW)

(21) Appl. No.: 14/289,777

(22) Filed: May 29, 2014

(51) Int. Cl. B23K 26/40; B23K 26/06; B23K 26/38

(52) U.S. Cl. CPC B23K 26/408; B23K 26/383; B23K 26/0635

(57) ABSTRACT

A method and system for formation of vertical microvias in an opaque ceramic thin-plate by femtosecond laser pulses are introduced. The method includes (a) thin an opaque ceramic substrate and reduce its thickness to a range of 20-100 μm to provide the ceramic thin-plate; (b) place the ceramic thin-plate on a carrier; and (c) drill the ceramic thin-plate by the femtosecond laser pulses, wherein the femtosecond laser pulses have the following parameters, including a pulse width <100 fs, a pulse frequency of 1,000˜10,000 Hz, a laser with a central wavelength of 800 nm, and a movable stage with a speed of 20-200 μm/s. Hence, vertical mirovias with high aspect ratio can be fabricated in an opaque ceramic thin-plate.

### FIELD OF TECHNOLOGY

The present invention relates to laser-based drilling process methods, and more particularly, to a method and system for formation of vertical microvias in an opaque ceramic thin-plate by femtosecond laser pulses.

### BACKGROUND

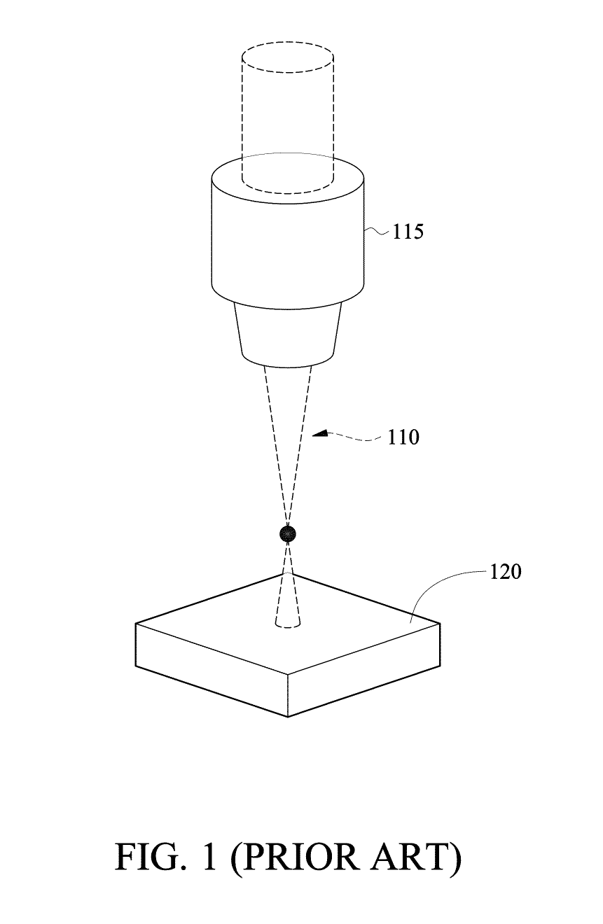

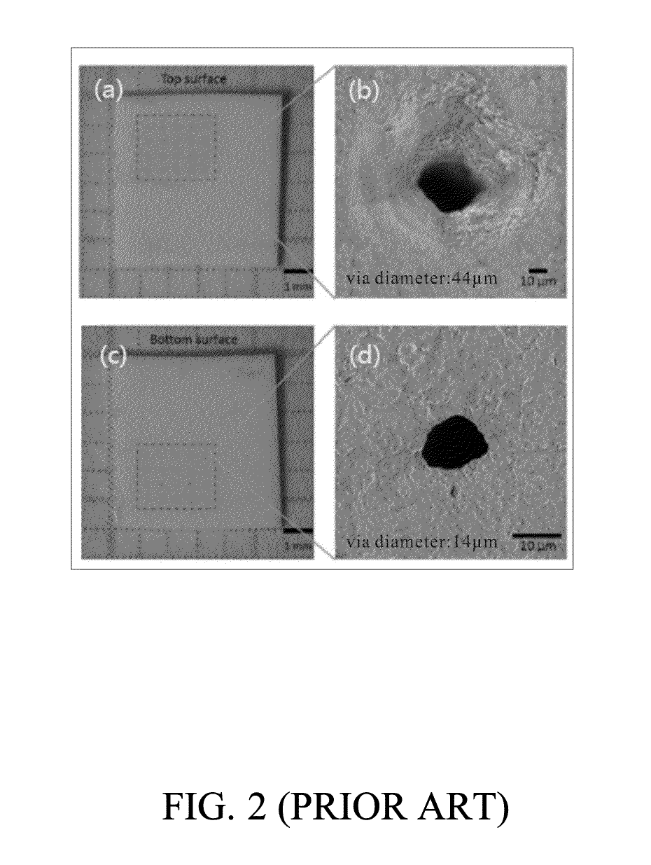

Femtosecond laser, so-called ultrafast laser, is characterized by femtoscale pulses (that is 10⁻¹⁵ second, fs). It is characterized with a central wavelength of 800 nm of infrared light. Due to its properties of instantaneously high energy power and insignificantly low accumulation of heat, femtosecond laser is widely applied to precise micro/nano processes. For a conventional method of femtosecond laser-drilling process (as shown in FIG. 1), a pulsed beam 110 through a objective 115 drills the sample 120 from its front side to the back side. Although the aforesaid drilling process is practicable in forming microvias with vertical sidewalls in materials, such as silicon wafer and glass, penetrable by a laser of a central wavelength of 800 nm, the aforesaid drilling process forms taper microvias undesirably in materials, such as an opaque ceramic substrate, not penetrable by a laser of a central wavelength of 800 nm, wherein the taper microvias each have a top-surface via diameter and a bottom-surface via diameter not equal to the former. For instance, a femtosecond laser-drilling process on an aluminum nitride substrate, the pulsed beam irradiates on its top surface and then exits its bottom surface, as shown in FIG. 2. FIG. 2 (a) shows an array of microvias on the top surface of the aluminum nitride thin-plate. FIG. 2(b) is a partial enlarged view of one of the microvias on the top surface of the aluminum nitride thin-plate, showing that the microvia is of a diameter of 44 μm. FIG. 2(c) shows an array of microvias on the bottom surface of the aluminum nitride thin-plate. FIG. 2(d) is a partial enlarged view of one of the microvias on the bottom surface of the aluminum nitride thin-plate, showing that the microvia is of a diameter of 14 μm.

With such taper microvias, each conductive pillar following the copper-filled vias process could cause an uneven electrical distribution of the impedance. This may further deteriorate the performance of the devices. This different phenomena of the vias formed by femtosecond laser drilling between an opaque and a transparent ceramic substrates may come from their different effective coverage angle of focus for a femtosecond laser pulse. For a transparent ceramic, the focus and the effective coverage angle of focus are stationary during the drilling process. On the contrary, it decreases in case of an opaque ceramic. This phenomenon may lead to two problems, one is the taper microvias, and the other is not easy to form through holes. Vertical microvias of a silicon wafer are conventionally formed by deep-reactive-ion-etch (DRIE) involved high cost and complicated processes such as lithography, vacuum, photomasks and so on. Although the DRIE process for vias formation is well-understood for silicon, it is inapplicable to the other materials, such as ceramic and glass. On the contrary, the advantages of laser-drilling are relative low costs and its process with polytropy, which draw lots of attentions. To increase the competitiveness of laser drilling, it is imperative to provide a method and system for formation of vertical microvias of an opaque ceramic substrate.

### SUMMARY

In view of the aforesaid drawbacks of the prior arts, the objective of this invention is to provide a method and system to form vertical microvias of an opaque ceramic thin-plate by femtosecond laser pulses. This system includes a titanium-sapphire laser generation, a thin-plate carrier, and a movable stage. It leads to fabricate vertical and high aspect ratio microvias of an opaque ceramic thin-plate.

To achieve the goals, this invention provides a method and a system, which comprising the following steps: (a) thin an opaque ceramic substrate to a thickness of 20-100 μm for a ceramic thin-plate; (B) place the ceramic thin-plate on a carrier; and (C) drill the ceramic thin-plate by femtosecond laser pulses. During the drilling process, the femtosecond laser pulses have the following parameters: a pulse width <100 fs, a pulse frequency of 1,000˜10,000 Hz, a central wavelength of laser of 800 nm, a movable stage with a speed of 20-200 μm/s and a laser power of 200-1000 mW.

The femtosecond laser pulses can be generated by a titanium-sapphire laser, but are not limited to it. The opaque ceramic thin-plate includes aluminum nitride, aluminum oxide, silicon carbide, but is not limited to above-mentioned materials.

To achieve the goals, this invention disclose another method for it, which comprises the following: (a) form blind microvias on the ceramic substrate by femtosecond laser pulses, which aspect ratio is smaller than 5; (b) at some position, further focus the laser to form a through vias on the ceramic thin-plate, the diameter of it is similar to the blind microvia and its aspect ratio is larger than 5; and (c) remove the portion of the lower aspect ratio vias by thinning and then obtain an opaque ceramic thin-plate with a higher aspect ratio vias. The thickness of it is within 20-100 μm.

The femtosecond laser pulses can be generated by a titanium-sapphire laser, but are not limited to it. During the drilling process, the femtosecond laser pulses have the following parameters: a pulse width <100 fs, a pulse frequency of 1,000˜10,000 Hz, a central wavelength of laser of 800 nm, a movable stage with a speed of 20-200 μm/s and a laser power of 200-1000 mW. The opaque ceramic thin-plate includes aluminum nitride, aluminum oxide, silicon carbide, but is not limited to above-mentioned materials.

To achieve the goals, this invention provides another method for formation of vertical microvias of a ceramic thin-plate by femtosecond laser pulses with the following parameters: a pulse width <100 fs, a pulse frequency of 1,000˜10,000 Hz, a central wavelength of laser of 800 nm, a movable stage with a speed of 20-200 μm/s and a laser power of 200-1000 mW.

### BRIEF DESCRIPTION

The objectives, the features, and the advantages of the present invention are hereunder illustrated with specific embodiments in conjunction with the accompanying drawings, in which:

FIG. 1 (PRIOR ART) is a schematic view of a conventional femtosecond laser drilling process;

FIG. 2 (PRIOR ART) shows the topographic pictures taken form microvias on an aluminum nitride thin-plate by a conventional femtosecond laser drilling process;

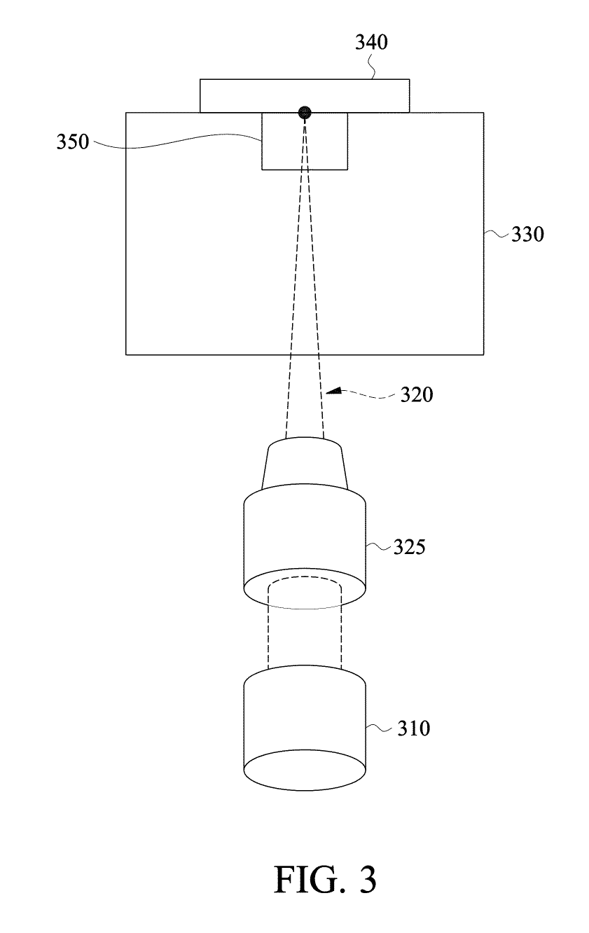

FIG. 3 is a schematic view of a system of this invention for laser-based drilling on an opaque ceramic thin-plate;

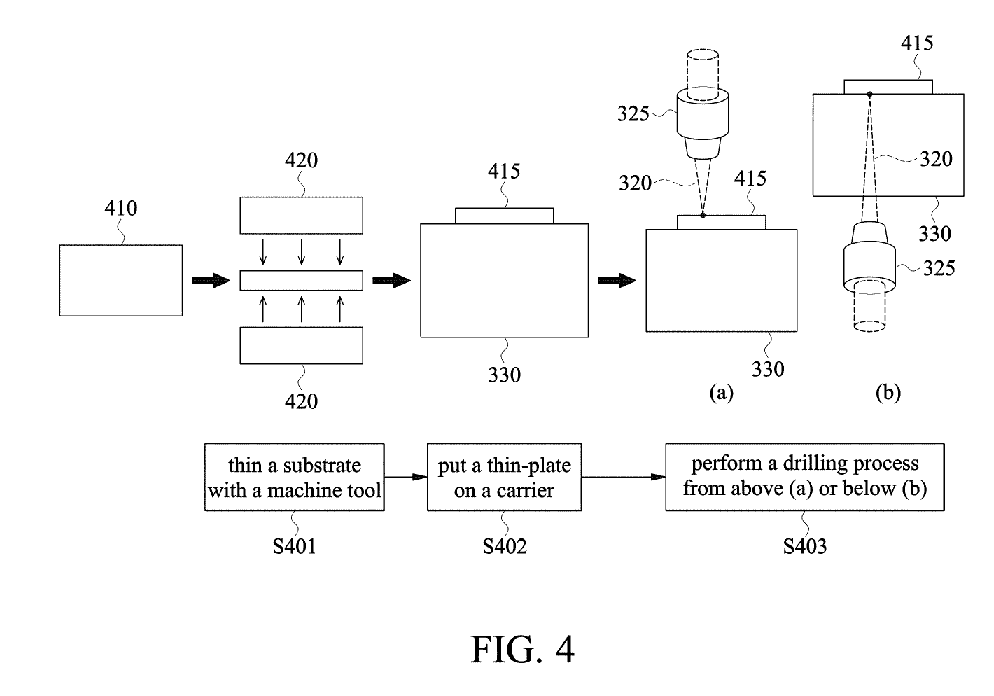

FIG. 4 is a schematic view of the process flow of a method for formation of vertical microvias in an opaque ceramic thin-plate by femtosecond laser pulses according to the present invention; and

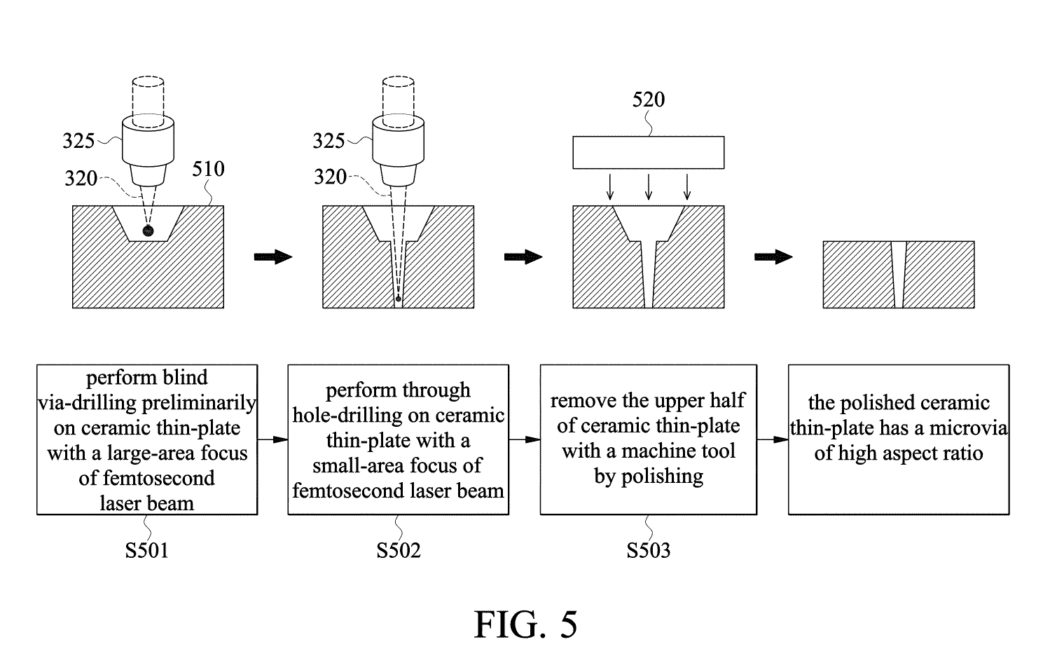

FIG. 5 is a schematic view of the process flow of another method for forming vertical microvias in an opaque ceramic thin-plate by femtosecond laser pulses.

### DETAILED DESCRIPTION

A detailed description of the further features and advantages of the present invention is given below. Therefore, a person skilled in the art can understand and implement the technical contents of the present invention and readily comprehend the objectives, features, and advantages thereof by reviewing the disclosure of the present specification.

A titanium-sapphire laser pulse is one of ultrafast pulses, which means its pulse width is extremely short. Therefore, the quality of the microvias would be significantly improved due to it provides well-defined annealing areas and few thermal budget effects. However, it would lead to form a seriously taper via of a substrate with a non-penetrable property for a central wavelength of 800 nm, such as aluminum nitride. Therefore, the present invention demonstrates, in this embodiment, a method and a system for formation of vertical microvias in an opaque or near-infrared light-absorbed ceramic thin-plate (such as aluminum nitride, aluminum oxide, silicon carbide and so on) by femtosecond laser pulses, which characterized a central wavelength of 800 nm, a pulse width <100 fs, a laser power of 200˜1,000 mW, and a frequency of 1,000˜10,000 Hz.

FIG. 3 shows a schematic view of a system for forming vertical microvias in an opaque ceramic thin-plate by femtosecond laser pulses. This invention provides a system, which includes a titanium-sapphire laser source 310 characterized with a central wavelength of 800 nm, a pulsed beam 320 of a pulse width <100 fs, a laser power of 200˜1,000 mW, and a pulse frequency of 1,000˜10,000 Hz, a 10× objective 325 and a thin-plate carrier 330 for carrying an opaque ceramic thin-plate 340.

In another embodiment of the system, a laser head is either movable or stationary. In the situation where the laser head is movable, the movable stage and the laser head are coupled together, thus the motion of the movable stage drives the laser head to move. In the situation where the laser head is stationary, the movable stage and the thin-plate carrier 330 are coupled together, such that the motion of the movable stage drives the opaque ceramic thin-plate to move. The movable stage is a three-axis movable stage with a moving speed of 20-200 μm/s along the x or y axis, while its moving speed of the z-axis is approximately 10 μm/s.

FIG. 4 shows a schematic view of the process flow of a method for formation of vertical microvias in an opaque ceramic thin-plate by femtosecond laser pulses. The invention provides a method for forming vertical microvias in an opaque ceramic thin-plate by femtosecond laser pulses. In this embodiment, the process flow of the method comprises the following steps: first, thin an opaque ceramic substrate (its thickness is larger than 500 μm) 410, and then reduce its thickness down to 20˜200 μm by single or double sides thinning process to form an opaque ceramic thin-plate 415 (S401). Afterwards, place the opaque ceramic thin-plate 415 on a thin-plate carrier 330 (S402). Then, perform femtosecond laser-drilling process by controlling a movable stage (S403). Referring to FIG. 3, in this embodiment, femtosecond laser pulses are generated by a titanium-sapphire laser source 310, which characterized with a central wavelength of 800 nm, a pulsed beam 320 of a pulse width <100 fs, a laser power of 200˜1,000 mW, and a pulse frequency of 1,000˜10,000 Hz. An objective with 10× 325 is used to focus the pulsed beam 320 and the thin-plate carrier 330 is disposed on the three-axis movable stage. The movable stage is a three-axis movable stage with a moving speed of 20-200 μm/s along the x-axis or along the y-axis, while its moving speed of the z-axis is approximately 10 μm/s. The thin-plate carrier 330 is made of any material (such as glass or silicon wafer), which does not absorb near-infrared lights. In this embodiment, the thin-plate is made of aluminum nitride, and the carrier can be a solid or a hollow with various shapes 350. Thus, the femtosecond pulses can be used to drill a thin-plate on a stage from their foreside or backside.

FIG. 5 shows a schematic view of the process flow of another method for formation of vertical microvias in an opaque ceramic thin-plate by the femtosecond laser pulses. In this embodiment, the process flow of the method comprises the following steps: (1) use a large-area focusing beam (S501) to drill blind-vias of an opaque ceramic thin-plate 510 preliminarily by femtosecond laser pulses; (2) use a small-area focusing beam, at the same position of spot, to drill through vias of an opaque ceramic thin-plate 510 by femtosecond laser pulses (S502); (3) remove the upper portion of the ceramic thin-plate with microvias of large AR ratio by (S503). Final, obtain an opaque ceramic thin-plate with vertical microvias.

This invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A method for formation of vertical microvias in a ceramic thin-plate by femtosecond laser pulses, which comprises the following steps:
(a) thin an opaque ceramic substrate and reduce its thickness to a range of 20-100 μm to provide the ceramic thin-plate;
(b) place the ceramic thin-plate on a carrier; and
(c) drill the ceramic thin-plate by femtosecond laser pulses,
wherein the femtosecond laser pulses are controlled with the following parameters: a pulse width <100 fs, a pulse frequency of 1,000˜10,000 Hz, a laser with a central wavelength of 800 nm and a movable stage with a speed of 20-200 μm/s.

2. The method of claim 1, wherein the femtosecond laser pulses are generated by a titanium-sapphire laser generation.

3. The method of claim 1, wherein the ceramic thin-plate is made of aluminum nitride, aluminum oxide, and silicon carbide, but is not limited to these materials.

4. The method of claim 1, wherein a power of the titanium-sapphire laser is of a range of 200-1000 mW.

5. A method for formation of vertical microvias in a ceramic thin-plate by femtosecond laser pulses comprises the steps:
(a) drill blind microvias of a ceramic substrate by femtosecond laser pulses such that the blind microvias each have an aspect ratio <5;
(b) drill through vias, at the same position of the blind microvias, of the ceramic thin-plate by the femtosecond laser pulses such that the through vias each have an aspect ratio >5;
(c) remove the portion of the microvias with an aspect ratio <5 and retain the portion of the microvias with an aspect ratio >5.

6. The method of claim 5, wherein the femtosecond laser pulses are generated by a titanium-sapphire laser.

7. The method of claim 5, wherein the ceramic thin-plate is thinned to a thickness of 20-100 μm.

8. A system for formation of vertical microvias in a ceramic thin-plate by femtosecond laser pulses, which comprises: a titanium-sapphire laser with parameters: a pulse with a central wavelength of 800 nm, a pulse width <100 fs, a laser power of 200˜1,000 mW, and a pulse frequency of 1,000˜10,000 Hz and a movable stage with a speed of 20-200 μm/s.

9. The system of claim 8, wherein the ceramic thin-plate is made of one of aluminum nitride, aluminum oxide, and silicon carbide.

10. The system of claim 8, wherein a thickness of the ceramic thin-plate is 20-100 μm.
